(19) United States
(12) Patent Application Publication
(10) Pub. No.: US 2024/0185437 A1
(43) Pub. Date: Jun. 6, 2024

(54) Computer-Implemented Method and System for Training a Machine Learning Process

(71) Applicant: ZF Friedrichshafen AG, Friedrichshafen (DE)

(72) Inventors: Saikiran Kannaiah, Friedrichshafen (DE); Jonas Riebel, Friedrichshafen (DE); Benjamin Wagner, Friedrichshafen (DE)

(21) Appl. No.: 18/554,288

(22) PCT Filed: Apr. 4, 2022
(86) PCT No.: PCT/EP2022/058835

§ 371 Date: Oct. 6, 2023

(30) Foreign Application Priority Data
Apr. 8, 2021 (DE) 10 2021 203 492.6

(51) Int. Cl. G06T 7/246; G06T 7/73; G06V 10/24; G06V 10/774; G06V 10/776; G06V 10/82; G06V 20/58

(52) U.S. Cl. CPC G06T 7/248; G06T 7/73; G06V 10/242; G06V 10/774; G06V 10/776; G06V 10/82; G06V 20/58; G06T 2207/10016; G06T 2207/20081; G06T 2207/30204; G06T 2207/30241; G06T 2207/30261

(57) ABSTRACT

A computer-implemented method, includes: providing temporally sequential global traffic scenarios as temporally sequential frames in a global coordinate system; characterizing all objects in the global traffic scenarios with various markers; determining the ego pose of the ego vehicle in the temporally sequential frame; transforming each of the frames with the marked objects on the basis of the determined ego pose into a local coordinate system as a local traffic scenario, wherein the transformed frames up to a first point in time used as historic frames, and the transformed frames from the first point in time up to a second point in time used as ground truth frames; and training the machine learning process on the basis of the historic frames (1a, . . . ,1e) for determining future local traffic scenarios up to a second point in time as future frames and comparing the future frames with the corresponding ground truth frames (2a, . . . ,2e).

### CROSS-REFERENCE TO RELATED APPLICATIONS

The present application is related and has right of priority to German Patent Application No. DE102021203492.6 filed on Apr. 8, 2021 and is a U.S. national phase of PCT/EP2022/058835 filed on Apr. 4, 2022, both of which are incorporated by reference in their entirety for all purposes.

### FIELD OF THE INVENTION

The invention relates generally to a computer-implemented method for training a machine learning method for identifying future trajectories of objects with respect to an ego vehicle. The invention further relates generally to a system.

### BACKGROUND

An autonomous or fully autonomous vehicle is a vehicle that is capable of sensing surroundings and navigating with little or no user input. This takes place by using sensor devices, such as radar, LIDAR systems, cameras, ultrasound, and the like.

The vehicle analyzes the sensor data with respect to the road course, other road users and their trajectory. Moreover, the vehicle must appropriately react to the collected data and calculate control commands in accordance with the collected data and transmit these control commands to actuators in the vehicle.

In order for an autonomous vehicle to be able to reach the destination, however, the autonomous vehicle must not only perceive and interpret surroundings, but also predict what could happen. These predictions are approximately on the order of one to three seconds, for example, when a road user turns or a pedestrian crosses the street, so that the autonomous vehicle can plan/re-plan future route safely and without collisions.

It is currently a challenge for the operation of autonomous vehicles to be able to predict the future route or the trajectory of road users in the surroundings of the autonomous vehicle. This is particularly difficult, in particular, as traffic continuously increases and sensor data density continuously increases.

DE 10 2018 222 542 A1 discloses a method for predicting the trajectory of at least one controlled object, wherein a current position of the object determined by physical measurement is provided, at least one anticipated destination of the movement of the object is provided, taking into account physical observations of the object and/or the surroundings in which the object moves. At least one anticipated preference is ascertained, which takes place as the object is controlled towards the at least one anticipated destination.

### SUMMARY OF THE INVENTION

Example aspects of the invention provide a method and a system, with which the trajectory of road users can be better predicted.

In example embodiments, a computer-implemented method for training a machine learning method for identifying future trajectories of objects with respect to an ego vehicle, includes:
providing temporally sequential global traffic scenarios as temporally sequential frames in a global coordinate system;
characterizing all objects in the global traffic scenarios with various markers;
determining the ego pose of the ego vehicle in the temporally sequential frames;
transforming each of the frames with the marked objects on the basis of the determined ego pose into a local coordinate system as a local traffic scenario, such that the particular frame has the same orientation as the ego vehicle in the particular frame and the coordinates of the ego vehicle are the coordinate origin, such that the local traffic scenarios have the same orientation as the ego vehicle, the transformed frames up to a first point in time being used as historic frames and the transformed frames from the first point in time up to a second point in time being used as ground truth frames; and
training the machine learning method on the basis of the historic frames for determining future local traffic scenarios up to a second point in time as future frames and comparing the future frames created by the machine learning method with the corresponding ground truth frames.

Frames are, for all intents and purposes, traffic scenarios (one single traffic scenario) up to a certain point in time. The frames can be considered as individual images of the temporally sequential traffic scenarios. Traffic scenarios can therefore be formed from temporally sequential frames of traffic scenarios.

The ego pose is essentially at least the orientation of the ego vehicle.

Ground truth traffic scenarios (frames) are the traffic scenarios that actually arise, e.g., the traffic scenarios that actually arise after the first point in time up to the second point in time having the trajectories that have actually been traveled by the road users after the first point in time.

A traffic scenario can be made up of a number / quantity of different moving objects (bicycle/passenger car/pedestrian) and/or stationary objects (traffic light/traffic sign) in the surroundings of the ego vehicle. Stationary objects, such as traffic signs, road markings, light signal systems, pedestrian crossings, and obstacles, are located at one precisely determined position. Moving objects, such as bicycles, passenger cars, etc., have a dynamic behavior (trajectory), such as speed, acceleration/deceleration, distance from the road centerline, etc.

The term “ego vehicle” can be understood to be the vehicle, the surroundings of which are to be monitored. The ego vehicle can be, in particular, a fully-autonomously- driving or semi-autonomously-driving motor vehicle for travel on roads, which motor vehicle is to at least partially independently steer. For this purpose, sensors, etc., which can sense the surroundings are usually arranged on the ego vehicle.

A trajectory denotes a quantity of positions and orientations that are temporally and spatially linked to one another, e.g., a route of a road user along and/or in the frames.

According to example aspects of the invention, all frames are oriented on the basis of the ego pose, such that only the ego movement and the ego turn are represented thereby. The ego vehicle itself is not shown. Preferably, the final two seconds of the traffic scenarios are selected as historic frames and are used as the input training data with the ground truth frames.

Due to the machine learning method which is trained by the method according to example aspects of the invention, it is possible to create a prediction of the object trajectories on the basis of the complete frame as input.

In addition, due to the method according to example aspects of the invention, a machine learning method, for example, an artificial neural network, is trained in a simplified manner. The machine learning method is trained by utilizing the complete knowledge of, for example, the navigable lanes and traffic rules (static objects) as training data. The learning method which has thus been trained can then incorporate this knowledge into the prediction.

All the prior knowledge of road users is also used in the machine learning method which has thus been trained according to example aspects of the invention. As a result, the trained machine learning method can also incorporate this into the subsequent predictions. Furthermore, the past movements of the road users and the category to which these road users belong, such as, for example, pedestrian, passenger car, truck, bicycles, etc., can be taken into account in the learning method which has thus been trained according to example aspects of the invention by entering the complete frames into the learning method which has thereby been trained. On the basis thereof, it is possible for the machine learning method, which has thereby been trained to subsequently take all road users into account, without the computing time being affected thereby.

The social interactions can be taken into account by entering the frames which have been designed according to example aspects of the invention in the machine learning method, which has thus been trained by the method according to example aspects of the invention. On the basis thereof, it is possible for the machine learning method which has thereby been trained to subsequently take these social interactions into account in the prediction of the future movement of the road users.

Due to the method according to example aspects of the invention, a machine learning method can be trained to generate forward-looking traffic scenarios on the basis of historic frames and ground truth frames. As a result, an improved machine learning method can be generated, which delivers an improved prediction of the trajectories of moving objects in surroundings.

Due to the method according to example aspects of the invention, a machine learning method is trained on the basis of the complete frames and, therefore, the entirety of map information and the entirety of social interactions as well as due to the history of the historic trajectory as input and can therefore achieve better results after training.

The machine learning method which has been trained by the method is therefore capable of determining all trajectories in the traffic scenarios around the ego vehicle at once in advance. As a result, only one constant time is required for the prediction, which is independent of the number of road users, by incorporating, for example, the social interaction of the particular road users into the prediction as well as, for example, the historic prior knowledge of the road users into the future traffic scenarios to be determined.

In one example embodiment, the objects are formed as static objects and as moving objects, wherein the static objects and the moving objects are characterized at least by size and shape as markers. Each object is preferably represented by original size and length and width. Furthermore, static objects and moving objects can be characterized by different colors as markers. A RGB color palette which presents all available map information, such as lane centers and lane boundaries, is used for this purpose. For example, road users can be presented in gray.

In another example embodiment, the historic frames and the ground truth frames and the future frames created by the machine learning method have a time stamp. When the historic frames are transformed into an individual frame, each moving gray object (road user) represents a point in time at which the frame was created. As a result, the time increments can be presented together in a frame in connection with the objects. The decoding of the objects with respect to history and the associated time increment is therefore provided in the data structure itself.

In another example embodiment, the frames are designed as an image section from a particular traffic scenario, an image section being formed by a predefined radius about the coordinates of the ego vehicle, such that the ego vehicle is located in the center of the image section. As a result, the moving objects can be better tracked from the perspective of the ego vehicle and faster processing is also possible. Since all frames contain the tracking of all objects and their poses, only those objects that can be perceived from the perspective of the ego vehicle are necessary for determining relevant trajectories. The individually generated frames which have been reduced by the image section therefore only contain objects that are visible to this specific ego vehicle in its visual field. The radius can be freely selected. In particular, a radius of fifty meters (50 m) can be selected.

By selecting this radius, it is ensured that all movable and immovable objects that are necessary for autonomously controlling the ego vehicle for the next few seconds/minutes are detected. All frames are centered and oriented on the basis of the ego coordinates, e.g., the coordinates of the ego vehicle and the direction, such that only the ego movement and ego turn are represented and the ego vehicle itself is not shown. The ego vehicle is always located in the center of a frame as the coordinate origin.

In another example embodiment, the historic trajectory of moving objects, i.e., road users, is determined on the basis of the historic frames and the anticipated future trajectories generated by the machine learning method are determined on the basis of the future frames.

For this purpose, the future trajectories are extracted from the future frames created by the machine learning method and assigned to the associated object (road user).

Initially, the future frames are preferably rotated for this purpose in accordance with the ego pose in order to obtain the same orientation as the ego vehicle and the historic frames, e.g., the historic frames and the future frames are oriented identically with respect to one another. The ego pose means the position and the orientation of the ego vehicle. Thereafter, the contours and thus the objects (road users) and trajectories of the objects are preferably also detected in the rotated future frames and pose, e.g., orientation and coordinates, is determined and compared with the pose of the individual road users in the historic frames. As a result, an assignment can take place. If the assignment has been obtained as a result, the future trajectories can be assigned to the known road users.

In another example embodiment, the future trajectories of moving objects (road users) are determined on the basis of the ground truth frames. The machine learning method can then be trained on the basis of the historic trajectories from the historic frames and the future trajectories ascertained by the machine learning method. As a result, a targeted training of a machine learning method, for example, by iterative gradient methods, can be accomplished.

In another example embodiment, a quality of the machine learning method is determined by determining the difference between the ground truth trajectories and the anticipated future trajectories generated by the machine learning method as the mean absolute error (MAE):

$$MAE = \frac{1}{n} {\sum }_{i = 1}^{n} \vert {( ground truth trajectories )}_{i} - {( future trajectories )}_{i} \vert$$

wherein n is the number of frames.

This means that the difference between ground truth trajectories and the future trajectories is calculated. As a result, the quality of the machine learning method can be very quickly determined.

In another example embodiment, the traffic scenarios can be simulated in a bird's eye view in the virtual space. As a result, the historic frames and the ground truth frames are easily created.

In another example embodiment, the machine learning method is a deep learning method, which is trained by means of a gradient method. This learning method can be designed, for example, as a deep neural network. The network can be iteratively trained by gradient descent on the basis of the trajectories or the frames. A decoder-encoder structure can be used as the architecture of the artificial neural network.

The artificial neural network can be a convolutional neural network, in particular a deep convolutional neural network. The encoder is responsible for compressing the input signal by convolution and transforms the input into a low-dimensional vector. The decoder is responsible for the restoration. The decoder subsequently transforms the low-dimensional vector into the desired output.

Moreover, a system for training a machine learning method for identifying future trajectories of objects with respect to an ego vehicle, includes:
a memory unit for providing temporally sequential global traffic scenarios as temporally sequential frames in a global coordinate system, the global traffic scenarios including objects and all objects being characterized with various markers in the global traffic scenarios;
a processor for determining the ego pose of the ego vehicle in the temporally successive frames and for transforming each of the frames with the marked objects on the basis of the determined ego pose into a local coordinate system as a local traffic scenario, such that the particular frame has the same orientation as the ego vehicle, the transformed frames up to a first point in time being used as historic frames and the transformed frames from the first point in time up to a second point in time being used as ground truth frames; and
the processor for training the machine learning method on the basis of the historic frames for determining future local traffic scenarios up to a second point in time as future frames and comparing the future frames created by the machine learning method with the corresponding ground truth frames.

The example advantages of the method can also be transferred onto the system. The individual example embodiments of the method can also be applied on the system.

Further preferred example embodiments relate to a computer program product including commands which, when the program is run by the computer, prompt the computer to carry out the steps of the method according to the example embodiments.

Further preferred example embodiments relate to a computer-readable memory medium including commands, for example, in the form of the computer program product, which, when run by the computer, prompt the computer to carry out the method according to the example embodiments.

Further preferred example embodiments relate to a data carrier signal which transmits and/or characterizes the computer program according to the example embodiments. The computer program can be transmitted, for example, from an external unit to the system by the data carrier signal. The system can include, for example, a preferably bidirectional data interface for, among other things, receiving the data carrier signal.

### BRIEF DESCRIPTION OF THE DRAWINGS

Further example properties and advantages of the present invention are obvious from the following description with reference to the attached figures. Schematically:

FIG. 1: shows various historic frames;

FIG. 2: shows immovable objects in a frame;

FIG. 3: shows the ground truth frames;

FIG. 4: shows the historic frames and ground truth frames in table form;

FIG. 5: shows stacked frames as a single frame;

FIG. 6: shows the encoder and the decoder of the neural network; and

FIG. 7: shows a calculated future trajectory.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

In order for an autonomous vehicle to be able to reach the destination, it must perceive and interpret surroundings, and predict what could happen in the future. Sensors which sense the surroundings are used for this purpose, the sensors being installed on the vehicle. The collected sensor data must be processed and interpreted.

An essential precondition for the operation of an autonomous vehicle (ego vehicle) for each road user is to reliably determine the future positions (trajectories) of the road users from such sensor data. A machine learning method, for example, a neural network, can be used for this purpose. The machine learning method must be reliably trained, however, in order to correctly interpret the sensor data obtained.

According to example aspects of the invention, the computer-implemented method for training the machine learning method can be used to identify future trajectories of objects with respect to an ego vehicle. The current and previous positions of a road user in Cartesian coordinates can be used for this purpose.

Initially, temporally sequential global traffic scenarios are provided as temporally sequential frames in a global coordinate system. The trajectories and trajectory data are therefore inherent time-series data. The traffic scenarios are preferably represented by objects. The objects can be subdivided essentially into static objects and moving objects (road users).

Static objects are, for example, travel lanes and travel lane boundaries, traffic lights, traffic signs, etc. Moving objects in this case are primarily the road users, such as passenger cars, pedestrians, cyclists. These generate a trajectory. A trajectory refers to a quantity of positions and orientations which are temporally and spatially linked to one another, e.g., the route of the moving object.

These traffic scenarios are preferably created/simulated with reference to a data set on the basis of simulation data. Furthermore, the traffic scenarios are preferably simulated with respect to various cities in order to ensure that there is a sufficient quality of the simulation data. Therefore, large quantities of various traffic scenarios can be generated, on the basis of which the machine learning method can be trained.

The road users, in particular their trajectories, are presented in a top view, i.e., from a bird's eye view.

Each traffic scenario is presented as a frame.

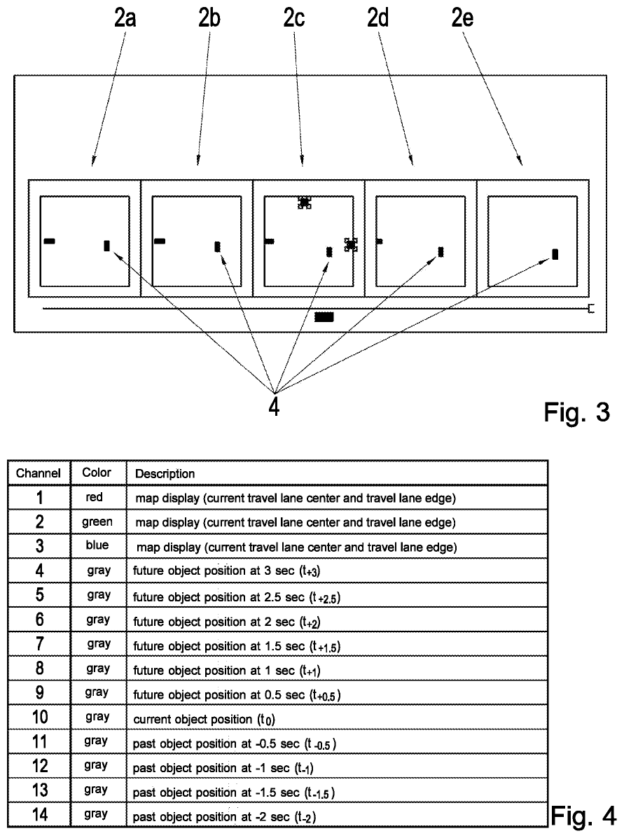

Historic frames 1a, . . . 1e (FIG. 1) are created, which extend from a point in time t=−2 seconds in the past up to a current first point in time t=0, and ground truth frames 2a, . . . , 2e (FIG. 3) are created, which extend from the first point in time up to a future second point in time. These can be used as input data into the machine learning method.

The historic frames provide the history, e.g., the trajectory covered so far in the case of moving objects.

Each object is preferably represented by original size and length and width. Furthermore, static objects and moving objects can be characterized by different colors as markers (RGB color palette) in the simulation. The RGB color palette is used to present all available map information, such as lane centers and lane boundaries.

For example, road users and historic trajectories 3 can be represented in gray in each of the simulated historic frames 1a, . . . , 1e and ground truth frames 2a, . . . , 2e.

The decoding of the history and of the time increment is therefore provided by this representation itself.

FIG. 1 shows various historic frames 1a, . . . , 1e, which contain the trajectories 3 of all objects. In order to be input into the machine learning method, the frames and thus the objects are rotated about the ego pose, such that the frames correspond to the perspective of the ego vehicle.

The trajectory 3 of an individual object in this case is identified practically by way of the fact that the historic frames 1a, . . . , 1e can be presented/perceived as an image sequence.

The historic frames are recorded up to a first point in time to starting from a point in time t =- 2 preceding the point in time to. This means that the last two (2) seconds are used as historic frames for an input for training the machine learning method.

Furthermore, the frames 1a, . . . , 1e are preferably designed as an image section from a particular traffic scenario, an image section being formed by a predefined radius about the coordinates of the ego vehicle. Therefore, only those objects are shown that can be perceived from the perspective of the ego vehicle, e.g., that would be perceived from the “ego perspective.”

The ego vehicle and the coordinates of the ego vehicle are therefore located in the center of the image section (coordinate origin). As a result, the objects can be better tracked from the perspective of the ego vehicle and faster processing is also possible. Since all frames can contain the tracking of all objects and their poses, the representation of the ego vehicle itself in the frames can be dispensed with.

The individually generated frames which have been reduced in the image section therefore only contain objects that are visible to this specific ego vehicle in the visual field. The radius can be freely selected. In particular, a radius of fifty meters (50 m) can be selected. As a result, it is ensured that all movable and immovable objects are detected that are necessary for autonomously controlling the ego vehicle for the next few seconds/minutes. Furthermore, the objects are centered in the direction of the ego vehicle, such that the ego vehicle is located with the ego coordinates in the center, e.g., the coordinate origin in this case, such that only the ego movement and ego turn are represented and the ego vehicle itself is not shown. As a result, the ego vehicle is always located in the center of the particular frame 1a, . . . , 1e and is not shown.

Furthermore, immovable objects can be shown, which are also rotated about the pose of the ego vehicle.

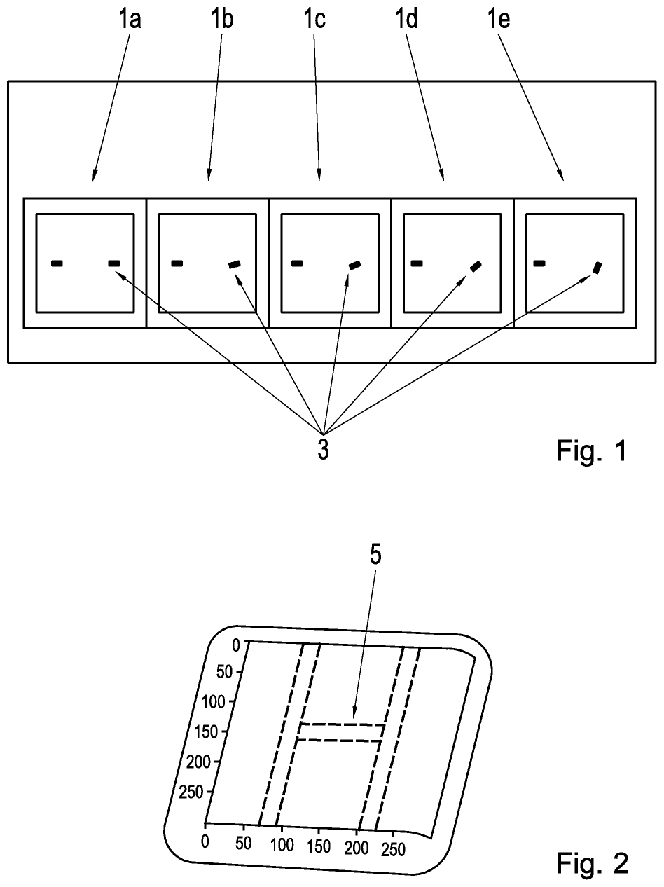

In FIG. 2, for example, the various travel lanes 5 are shown in green (dashed lines in this case) as immovable objects.

In addition, the ground truth frames 2a , . . . , 2e (FIG. 3) with the associated ground truth trajectories 4 are also created by the simulation. FIG. 3 shows the ground truth frames 2a , . . . , 2e with the associated ground truth trajectories 4.

FIG. 4 shows the presentation of the historic frames 1a, . . . , 1e and ground truth frames 2a , . . . , 2e in table form.

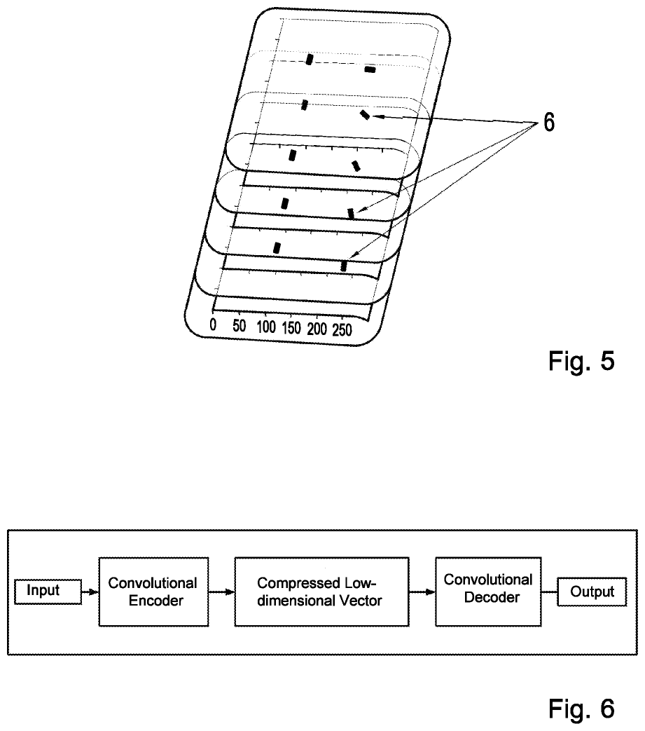

The historic frames 1a, . . . , 1e can be mapped onto one another and each shown in a single frame. FIG. 5 shows such a mapping, in which individual frames have been placed on top of one another practically as an image sequence, for identifying various objects and object trajectories, which are shown here, for example, on an object trajectory 6.

Thereafter, a machine learning method is preferably trained by the historic frames 1a, . . . , 1e and the ground truth frames 2a , . . . , 2e.

Such a learning method is preferably designed as an artificial deep neural network, which is described in greater detail in FIG. 6. The artificial deep neural network is preferably designed as an encoder and a decoder, which are iteratively trained by a gradient method. The artificial neural network can be iteratively trained on the basis of the trajectories 3, 4 from the historic frames 1a, . . . , 1e and the ground truth frames 2a , . . . , 2e and/or the frames 1a, . . . 1e, 2a , . . . , 2e themselves by gradient descent.

The neural network can be a convolutional neural network, in particular a deep convolutional neural network. The encoder is responsible for compressing the input signal by convolution. The decoder is responsible for restoring inputs. The encoder transforms the input into a low-dimensional vector. The decoder subsequently transforms the low-dimensional vector into the desired output.

Furthermore, a GAN (generative adversarial network) can also be used.

The neural network calculates future frames on the basis of the historic frames 1a, . . . , 1e.

Thereafter, the trajectories can be extracted from the future frames created by the neural network and assigned to the associated object (road user).

For this purpose, the future frames are initially preferably rotated for this purpose in accordance with the ego pose in order to obtain the same orientation as the ego vehicle and the historic frames; e.g., the historic frames 1a, . . . , 1e and future frames are oriented identically with respect to one another. Thereafter, the contours and thus the objects (road users) are preferably also detected in the rotated future frames and pose, e.g., orientation and coordinates, is determined and compared with the pose of the individual known objects at the point in time t. If an assignment has been obtained as a result, the future trajectories can be assigned to the known road users or objects.

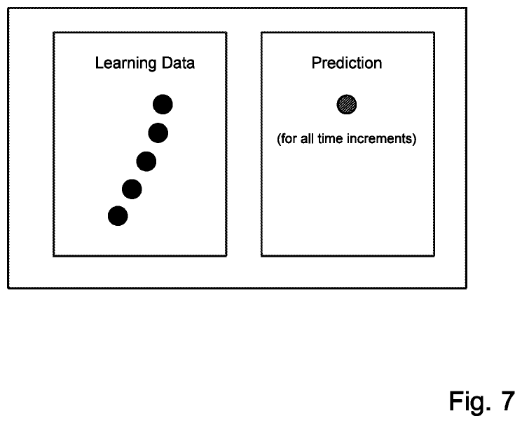

FIG. 7 shows a calculated future trajectory, wherein the last six steps in FIG. 7 are combined as “prediction trajectory (right)” and a ground truth trajectory (left).

The machine learning method can be evaluated on the basis of the method of soft-Dice loss (similarity index). This indicates the extent of overlap between the future frames from a bird's eye view and the ground truth frames in a bird's eye view with respect to the original object size.

Furthermore, a quality of the machine learning method can be determined by determining the difference between the ground truth trajectories 4 and the anticipated future trajectories generated by the machine learning method as the mean absolute error (MAE):

$$MAE = \frac{1}{n} {\sum }_{i = 1}^{n} \vert {( ground truth trajectories )}_{i} - {( future trajectories )}_{i} \vert$$

wherein n is the number of frames.

The neural network can be trained by the method according to example aspects of the invention such that the neural network therefore takes map information and driving context into account in the prediction of the future trajectories of the road users and takes the prior knowledge of the road users into account in the prediction of the future trajectories of the road users and takes social interactions into account in the prediction of the future trajectories between the road users.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### Reference Characters

1a , . . . , 1e historic frames
2a, . . . , 2e ground truth frames
3 historic trajectories
4 ground truth trajectories
5 travel lanes
6 object trajectory

1-15. cancelled

16. A computer-implemented method for training a machine learning process for identifying future trajectories of objects with respect to an ego vehicle, comprising:
providing temporally sequential global traffic scenarios as temporally sequential frames in a global coordinate system;
characterizing all objects in the global traffic scenarios with various markers;
determining the ego pose of the ego vehicle in the temporally sequential frames;
transforming each of the frames with the marked objects on the basis of the determined ego pose into a local coordinate system as a local traffic scenario such that each of the frames has the same orientation as the ego vehicle in the respective frame and the coordinates of the ego vehicle are the coordinate origin and the local traffic scenarios have the same orientation as the ego vehicle, wherein the transformed frames up to a first point in time are used as historic frames (1a , . . . , 1e), and the transformed frames from the first point in time up to a second point in time are used as ground truth frames (2a, . . . ,2e);
training a machine learning process on the basis of the historic frames (1a , . . . , 1e) for determining future local traffic scenarios up to a second point in time as future frames and comparing the future frames created by the machine learning process with the corresponding ground truth frames (2a, . . . ,2e).

17. The method of claim 16, wherein the objects are formed as static objects and as moving objects and are characterized at least by size and shape as markers.

18. The method of claim 17, wherein the static objects and the moving objects are characterized by different colors as markers.

19. The method of claim 16, wherein the historic frames (1a, . . . ,1e) and the ground truth frames (2a, . . . ,2e) and the future frames created by the machine learning process have a time stamp.

20. The method of claim 16, wherein the frames are configured as an image section from a particular traffic scenario, an image section being formed by a predefined radius about the coordinates of the ego vehicle such that the ego vehicle is located in the center of the image section.

21. The method of claim 16, wherein a historic trajectory of moving objects is determined on the basis of the historic frames (1a, . . . ,1e) and the anticipated future trajectories generated by the machine learning process are determined on the basis of the future frames.

22. The method of claim 21, wherein a ground truth trajectory (4) of moving objects is determined on the basis of the ground truth frames (2a, . . . ,2e) and the machine learning process is trained on the basis of the historic trajectory (3) and the ground truth trajectory (4).

23. The method of claim 22, wherein a quality of the machine learning process is determined by determining the difference between the ground truth trajectories (4) and the anticipated future trajectories generated by the machine learning method as the mean absolute error (MAE):
MAE=1/nΣᵢ₌₁ⁿ|(ground truth trajectories)ᵢ−(future trajectories)ᵢ|

wherein n is the number of frames.

24. The method of claim 16, wherein the traffic scenarios are simulated in a bird's eye view in the virtual space.

25. The method of claim 16, wherein the machine learning process is a deep learning process trained by a gradient method.

26. The method of claim 25, where the deep learning process has an encoder and a decoder.

27. A system for training a machine learning process for identifying future trajectories of objects with respect to an ego vehicle, comprising:
one or more memory units for providing temporally sequential global traffic scenarios as temporally sequential frames in a global coordinate system, the global traffic scenarios including objects characterized with various markers in the global traffic scenarios;
one or more processors configured for determining an ego pose of the ego vehicle in the temporally sequential frames and for transforming each of the frames with the marked objects on the basis of the determined ego pose into a local coordinate system as a local traffic scenario such that each of the frames has the same orientation as the ego vehicle in the respective frame and the coordinates of the ego vehicle are the coordinate origin and the local traffic scenarios have the same orientation as the ego vehicle, wherein the transformed frames up to a first point in time are used as historic frames (1a, . . . ,1e), and the transformed frames from the first point in time up to a second point in time are used as ground truth frames (2a, . . . ,2e), wherein the one or more processors are further configured for training the machine learning process on the basis of the historic frames (1a, . . . ,1e) for determining future local traffic scenarios up to a second point in time as future frames and comparing the future frames created by the machine learning process with the corresponding ground truth frames (2a, . . . ,2e).

28. A non-transitory computer program product, comprising commands which, when the program product is run by a computer, prompt the computer to carry out the method of claim 16.

29. A non-transitory computer-readable medium, comprising commands which, when run by a computer, prompt the computer to carry out the method of claim 16.

30. A data carrier signal, which transmits the computer program product of claim 28.
